(19) United States
(12) Patent Application Publication
(10) Pub. No.: US 2025/0272774 A1
(43) Pub. Date: Aug. 28, 2025

(54) SYSTEM AND METHOD FOR WIDESPREAD DISSEMINATION OF COLLEGE EVENT INFORMATION AND TICKETS

(71) Applicant: College Tickets LLC, Deerfield, IL (US)

(72) Inventor: Jacob Birg, Evanston, IL (US)

(73) Assignee: College Tickets LLC, Deerfield, IL (US)

(21) Appl. No.: 19/055,221

(22) Filed: Feb. 17, 2025

Related U.S. Application Data
(60) Provisional application No. 63/558,788, filed on Feb. 28, 2024.

(51) Int. Cl. G06Q 50/20; G06Q 10/02

(52) U.S. Cl. CPC G06Q 50/205; G06Q 10/02

(57) ABSTRACT

A computer-implemented system for widespread dissemination of college event information for multiple geographical regions overcomes the inability of many event organizers to widely promote event college event information, and the inability of many prospective attendees to sufficiently research and identify college events that may be of interest. The system includes an event organizer portal for uploading event information from multiple event organizers in multiple geographical regions, an event management portal for identifying and rejecting unacceptable events, a central processing unit for storing the accepted event information in multiple categories and sorting it into multiple subcategories, and a user portal for accessing and displaying desired event information and for ordering ticket(s) to a selected event. A corresponding method is also provided.

### FIELD OF THE INVENTION

This invention is directed to a system and method for widespread dissemination of information and tickets pertaining to college events.

### BACKGROUND OF THE INVENTION

“College events” or “events” include sports events, concerts, plays, theater, dances, political gatherings, and other events that are either open to the public (public events) or limited to select target audiences (private events) and are hosted by college event hosts (“event hosts”). “Event hosts” include colleges, student organizations, and/or local venues who typically use or make available college stadiums, auditoriums, arenas, theaters, and other on-campus or nearby facilities for the college events. “Event organizers” include persons in charge of organizing a college event. Due to cost restraints and the frequent use of venues that are not widely known to the public-at-large, the marketing of college events often targets only the current students and alumni. Unless an individual specifically seeks information about college events hosted by an event host not affiliated with the individual's own college or alma mater, he or she will be uninformed about most college events happening elsewhere. Except for select college events that are widely publicized, the limited dissemination of college event information can result in low attendance and empty seats, as well as depressed ticket prices and revenue.

College students have limited free time to look for college events that are not marketed to them and typically have little or no awareness of college events located at or near colleges other than their own. College alumni may also have limited time and incentive to seek college events hosted by colleges other than their alma mater. If an event host wants to promote its events beyond its own students and alumni, it must expend considerable time and expense. The scarce promotion of events by event organizers beyond their college students and alumni, and the scarce efforts by students and alumni to find college events hosted by other colleges, result in many college events being underattended and relatively unknown to the public at large.

On the other hand, college events are typically offered at more attractive prices and smaller, more congenial venues with more convenient parking than similar public events that are not hosted by college event hosts. This provides incentives for the event hosts to seek cost-effective ways of promoting their college events to the public-at-large, and for the public-at-large to use an efficient technique of identifying college events offered by several different college event hosts, if an efficient technique were available. There is thus a need or desire for a cost-effective way for college event hosts to promote and inform the public-at-large of their college events. There is a corresponding need or desire for an efficient way for members of the public-at-large to identify college events offered by multiple event hosts, including those affiliated with different colleges, and to purchase tickets to the various college events.

### SUMMARY

The invention is directed to a computer-implemented system for widespread dissemination of college event information for multiple event organizers, a computer-implemented method for widespread dissemination of college event information for multiple colleges, and a non-transitory computer-readable medium including one or more computer-readable instructions that, when executed by at least one processor of a computing device, cause the computing device to carry out the method. The system includes an event organizer portal that can be accessed by any student or college representative that has been approved and logged in as an event organizer. This enables students and others associated with a college to create and disseminate information regarding a wide variety of events, for example, concerts, theater, tournaments (e.g., chess or poker), sports, protests, political events, charity events, dances, and community service. Virtually any type of student organization, or other organization associated with the college, can use the system and method to upload and disseminate information regarding an event.

Event organizers can be screened according to their user credentials to verify that they are affiliated with a given event host. One way of doing this is to require a username email address associated with a college and consistent with college directories, for example an email address ending in .edu. This way, if a student graduates or leaves a given college, he or she will no longer have a username associated with that college. This also enables a virtually unlimited number of event organizers who are affiliated with a college to log in as event organizers and upload information for an event.

Once the event organizer login is accepted, the event organizer inputs information regarding the event. The information can include several event information categories, for example, college name, event name, event description, date and time of event, location of event, seating capacity, seating diagram (if applicable), ticket price(s), event organizer (for example, a student group), parking information (if applicable), and other miscellaneous information that is helpful to include.

The event information then passes from the user portal to an event management portal whose primary function is to screen and reject unacceptable events and pass the accepted event information to a central processing unit. The event management portal can screen the event information in one or more ways. One way is to analyze the language to see if it contains offensive words. This can be done by comparing the relevant event information against a list of unacceptable words. Another way is to analyze the event description to determine if the subject matter is acceptable. This can be done by either a) comparing the event description to a list of event types that are unacceptable, or b) comparing the event description to a limiting list of event descriptions that have been determined to be acceptable and rejecting all events that do not fit within those listed. Another way is to compare the event organizer against a list of event organizers (individual names or organizations) that have either been approved or disapproved. For example, a student organization with a history of trying to schedule unacceptable events might be listed as “disapproved” so that all events that are submitted by the organization are rejected. A more restrictive screening would be to compare the organizer to a list of “approved” organizers so that any event submitted by other than an approved organizer is rejected. Other event screening techniques can also be applied as alternatives to, or in addition to the foregoing.

The event management portal can be accessed and controlled by a system operator via an operator portal. The system operator may direct the event management portal to impose one or more tests to determine if an event should be accepted or rejected. An event that fails even one of the active tests is rejected. In order to be accepted, an event must pass all of the active tests if more than one test is used.

If an event is rejected, the event management portal can send a rejection notice back to the event organizer portal. If an event is not rejected, then the event management portal can send an acceptance notice back to the event organizer portal, so that the event organizer is informed of the event status. The event information for selected events can be passed to a central processing unit for further processing and dissemination.

The central processing unit can collect and store all the accepted event information from all the colleges and all the event organizers in the respective information categories. The central processing unit can then sort the event information from the event information categories into event information subcategories for selection of an event by a user and can pass the selected event information to a user portal that interfaces with the user. For example, all the event information corresponding to a geographical region (category) can be separated into subcategories for each of the individual geographical regions. All event information corresponding to an event description (category) can be separated into subcategories for each type of event. All information corresponding to an event date, time, and/or location can similarly be divided into corresponding subcategories as desired by the user. For example, a user may seek information concerning all concerts at or near the University of Iowa occurring between June and August. By selecting the proper categories (e.g. geographical region) and subcategories (e.g., Iowa City or Eastern Iowa, concert, and date range), the central processing unit will perform the requested sorting and send the requested event information to the user portal. The central processing unit can also be used to process ticket orders and payments, and dispensation of electronic tickets, which can then be stored on a mobile device or printed by a user.

The user portal can be accessed and used by any member of the public. The user can login as a guest to retrieve event information and can then set up an account with login credentials in order to purchase one or more tickets. The user portal can include a command menu which can, for example, include commands for event category, event subcategory, selection of a specific event, ticket ordering, and payment information. For example, a user can select an event category and an event subcategory to identify specific events that may be of interest. The user can then select a specific event and request ticket pricing information, as well as information regarding available seats. If suitable seats are identified at suitable prices, the user can then order one or more tickets and submit payment information. All user commands can pass from the user portal to the central processing unit, which in turn performs the necessary sorting of event information and passes it to the user portal where it can be displayed, as well as receiving and processing ticket orders and payments, and dispensing electronic ticket(s) to the user via the user portal.

The system and method of the invention enable widespread dissemination of any and all college events to anyone who may have an interest in attending. The system and method of the invention solve the problems of narrow dissemination and attendance at many college events, occurring because the event organizers may lack sufficient budget for widespread dissemination, and/or because students, alumni, and other members of the public lack sufficient time to perform in-depth research of college events that may be of interest to them.

With the foregoing in mind, it is a feature and advantage of the invention to provide a computer-implemented system for widespread dissemination of college event information for multiple geographical regions, including those affiliated with different colleges, which includes the following components:
an event organizer portal accessible by at least one event organizer for each of the multiple geographical regions for receiving event information for a college event from the event organizer;
the event organizer portal including at least an event organizer login interface and a space (e.g., virtual space) for uploading the event information, the event information including multiple event information categories, the event information categories including at least a geographical region name, a description of the college event, a date and time for the event, a location for the event, and at least one ticket price for attending the event;
an event management portal for receiving the event information from the event organizer portal, analyzing the event information to determine whether to accept or reject the college event, and sending a rejection notice to the event organizer portal if the college event is rejected;
a central processing unit for receiving the event information for all college events that are accepted, storing the event information for accepted college events from the multiple geographical regions, and sorting the stored event information according to subcategories within the event information categories; and
an online user portal accessible by individual users, including a user command menu for accessing and displaying the stored event information for one or more of the event information categories and/or subcategories, for selecting a college event from the one or more event information categories and/or subcategories categories, and for ordering one or more tickets to the selected college event.

It is also a feature and advantage of the invention to provide a computer-implemented method for widespread dissemination of college event information for multiple geographical regions including at least ten geographical regions, the method being performed by a computer system comprising at least one processor, the method including the following steps:
receiving event information for college events from at least one event organizer for each geographical region, the event information including multiple event information categories, the event information categories including at least a geographical region name, a description of the college event, a date and time for the event, a location for the event, and at least one ticket price for attending the event;
analyzing the event information for each college event to determine whether to accept or reject the college event, and sending a rejection notice to the at least one event organizer for each college event that is rejected;
receiving and storing the event information for each college event that is accepted from each of the geographical regions in the at least one processor;
sorting the stored event information from all of the geographical regions according to subcategories within the event information categories; and
providing an online user portal accessible by individual users, including a user command menu for accessing and displaying the stored event information for one or more of the event information categories and/or subcategories, for selecting a college event from the one or more categories and/or subcategories, and for ordering one or more tickets to the selected college

It is also a feature and advantage of the invention to provide a non-transitory computer-readable medium comprising one or more computer-readable instructions that, when executed by at least one processor of a computing device, cause the computing device to:
receive event information for college events from at least one event organizer for each of multiple geographical regions, the event information including multiple event information categories, the event information categories including at least a geographical region name, a description of the college event, a date and time for the event, a location for the event, and at least one ticket price for attending the event;
analyze the event information for each college event to determine whether to accept or reject the college event, and send a rejection notice to the at least one event organizer for each college event that is rejected;
receive and store the event information for each college event that is accepted from each of the geographical regions in the at least one processor;
sort the stored event information from all of the geographical regions into one or more subcategories within the event information categories; and
provide individual users with an online user portal including a user command menu for accessing and displaying the stored event information for one or more of the event information categories and/or subcategories, for selecting a college event from the one or more categories and/or subcategories, and for ordering one or more tickets to the selected college event.

The foregoing and other features and advantages of the invention will become further apparent from the following Detailed Description, read in conjunction with the accompanying drawings. The Detailed Description and drawings are intended to provide exemplary, non-limiting embodiments of the invention.

### BRIEF DESCRIPTION OF THE DRAWINGS

The accompanying drawings illustrate a number of embodiments and are a part of the specification. Together with the following description, these drawings demonstrate and explain various principles of the present disclosure.

FIG. 1 is a block diagram of one embodiment of a computer system for implementing the invention.

FIG. 2 is a block diagram showing the key system components and flow of information for the computer-implemented system and method of the invention.

FIG. 3 is a block diagram showing the key elements of an event organizer portal useful in the system and method of the invention.

FIG. 4 is a block diagram showing the key elements of an event management portal useful in the system and method of the invention.

FIG. 5 is a block diagram showing the key elements of a central processing unit useful in the system and method of the invention.

FIG. 6 is a block diagram showing the key elements of a user portal useful in the system and method of the invention.

Throughout the drawings, identical reference characters and descriptions indicate similar, but not necessarily identical, elements. While the embodiments described herein are susceptible to various modifications and alternative forms, specific embodiments have been shown by way of example in the drawings and will be described in detail herein. However, the embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to a system and method for widespread dissemination of college event information for multiple geographical regions. The disclosed technology can overcome limitations associated with many college events in which the organizers and/or sponsors cannot otherwise accomplish widespread promotion and dissemination of event information, and the interested members of the public cannot otherwise become familiar with college events being hosted in various geographical regions.

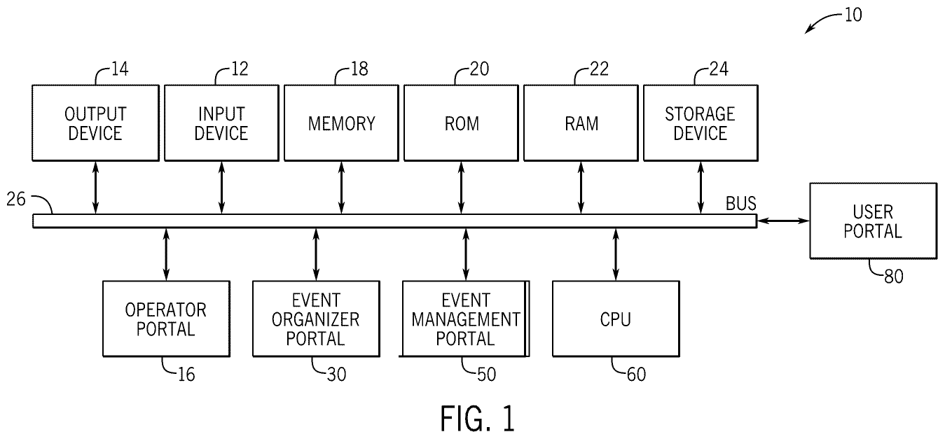

Referring to FIG. 1, one embodiment of a computer system 10 for use with the system and method of the invention can include an input portal 12 and an output portal 14, both of which can interface with the remaining system components as described below. An operator portal 16 is provided, which can be used by a system operator to make changes, upgrades, and/or repairs to the system software. As illustrated, the computer system 10 includes four processors, namely an event organizer portal 30, an event management portal 50, a central processing unit (CPU) 60, and a user portal 80 as described below. The functions of the event organizer portal 30, event management portal 50, the CPU 60, and the user portal 80 can also be integrated into fewer processors or a single processor having a suitable complex design or can be spread among additional processors for greater processing capability. The processors 30, 50, 60 and 80 are shown individually to facilitate explanation of the invention.

The computer system 10 can also include, as needed, standard components such as a system memory 18, a read only memory (ROM) 20, a random-access memory (RAM) 22, a storage device 24, and a system bus 26 that couples the computer system components together. The system and method of the invention can operate on an exemplary computer system 10 as shown, or on a plurality of computing devices networked together. The system bus 26 can be any of several types of bus structures such as a memory bus, a peripheral bus, or a local bus having a variety of configurations. The storage device 24 can be any kind of storage device such as a hard disk, magnetic disk, optical disk, or cloud-based storage device. The computer system components can provide nonvolatile storage of computer readable instructions, data structures, program modules, and other information and data for the computer system 10.

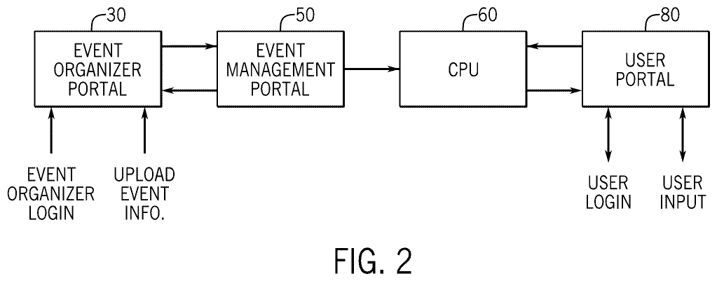

The input device 12 and the output device 14 of computer system 10 can suitably be configured to receive and send information via the internet, to and from individual event organizers who access the event organizer portal 30 and users who access the user portal 80. FIG. 2 is a block diagram showing the overall flow of information between key system components of the invention. The event organizer portal 30 (described further below) is designed for relatively convenient access to the system 10 by a wide variety of event organizers that are affiliated with any given college. The event organizer can, for example, be a college student or faculty member, or another person affiliated with the college. The event organizer portal 30 can be accessed using a personal computer, laptop, hand-held mobile device, or any other device that provides an event organizer with internet access to the computer system 10. The main functions of the event organizer portal are to provide a login that identifies the event organizer as being affiliated with a given college (for example, a college identification number or an email address ending in .edu), and a mechanism for uploading event information and receiving notification if an event is rejected or accepted.

The event management portal 50 (described further below) is designed mainly to analyze event information received via the event organizer portal to determine if the event can be accepted, or if it should be rejected for any reason. Examples of reasons for rejecting an event include without limitation the use of unacceptable (e.g., profane or prejudicial) language in the event information, unacceptable subject matter in the event description, access by an event organizer who has a history of submitting unacceptable events, and/or access by an event organizer who represents and organization having a history of submitting unacceptable events. The event management portal 50 informs the event organizer portal 30 if an event is rejected or accepted, and forwards event information for all accepted events to the central processing unit 60

The central processing unit 60 (described further below) receives information for all accepted events input from all event organizers in all covered geographical regions and stores the information in the various event categories (geographical region name, event name, description, date, time, and the like) that are input by the event organizers. The CPU also receives user commands from the user portal 80 and, upon receipt of a user command, sorts the event information into the categories and subcategories that are selected by the user. The central processing unit transmits the selected event information to the user portal, enabling the user to select a specific event, request further information (e.g., ticket prices and remaining seating information), order one or more tickets to the event, submit payment, and receive electronic tickets which can be printed or stored on the user's computer or mobile device.

The user portal 80 enables the user to login using login credentials, or as a guest for the purpose of reviewing event information. The user portal 80 can suitably be accessed via the internet using a personal computer, laptop, mobile device, or other device having internet access that is controlled by the user. The user can select from a menu of commands showing event categories and subcategories, to identify events of interest. The user can then select one or more events of interest and input further commands to receive price and ordering information, available seats, parking, and/or any other applicable information. All user commands are transmitted to and processed by the CPU. The user can order tickets, submit payment information, and receive electronic tickets via the user portal 80.

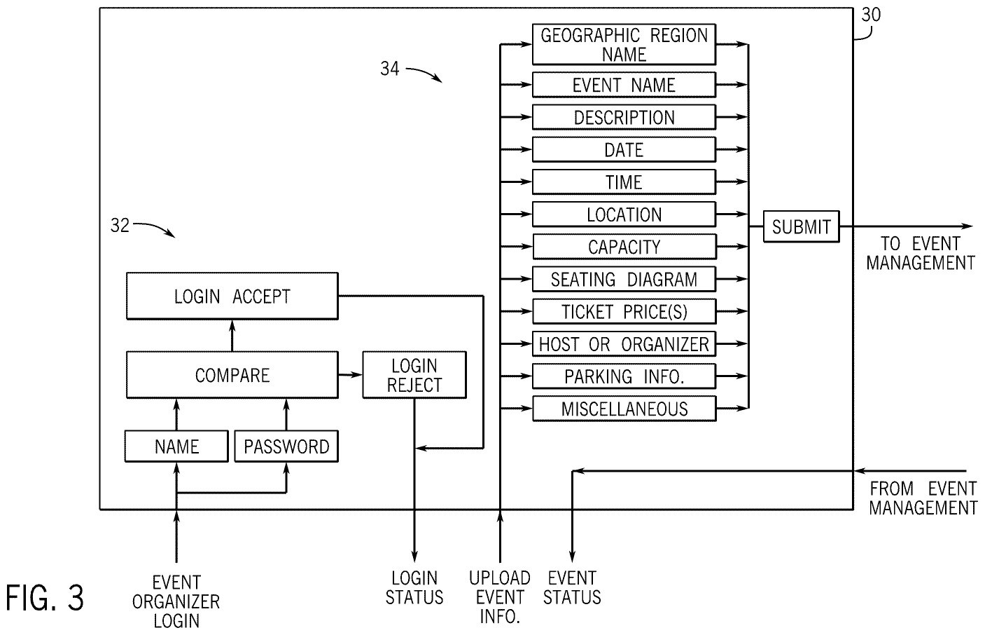

FIG. 3 is a block diagram showing details of an exemplary event organizer portal. The event organizer portal is accessible online by at least one event organizer in each of multiple geographical regions, for receiving event information for one or more college events in each of the geographical regions. The term “multiple geographical regions” can refer to any plural number of geographical regions and can, for example, refer to at least ten geographical regions, or at least 25 geographical regions, or at least 50 geographical regions, or at least 100 geographical regions. The term “geographical regions” includes without limitation cities, metropolitan areas, states, parts of states and other geographical regions in which junior colleges, four-year colleges, state universities, private universities, graduate universities, professional universities (e.g., law schools, medical schools, dental colleges, veterinary colleges), religious colleges, and any other institution dedicated to post-high school education are located. The geographical regions can also be identified as the names of specific colleges and/or universities, or a combination of college or university name and location. The event organizer portal can, if desired, be accessed by multiple event organizers affiliated with a particular college. For example, a college may have multiple student organizations, each of which can have one or more designated event organizers.

The event organizer portal 30 can include an event organizer login feature 32. The event organizer login feature can be designed to include an identifier that associates the event organizer with a given college. For example, the event organizer login feature can include a username that includes an email address ending in .edu, a student or faculty identification number, and/or a name or acronym representing the college. The event organizer login can also include a password. As shown in FIG. 3, the username and password are entered and compared with stored information, resulting in acceptance or rejection of the login attempt which can be communicated back to the event organizer.

Once the event organizer is successfully logged in, the event organizer portal 30 can be used to upload event information into a dedicated space 34, which can be a dedicated virtual space. The dedicated space can be one that is only accessible by the event organizer and for the selected event. The event information can be loaded into several event information categories, each of which provides valuable information concerning the event. For example, the dedicated space 34 can include event information categories identifying the geographical region, the event name, a description of the event, the date, time and location of the event, the event capacity, a seating diagram (if applicable), one or more ticket prices, the event host or organizer (individual or group hosting or organizing the event), parking information, and any miscellaneous information that is pertinent to the event. If attendance at the event is free, the ticket price can be indicated as “zero.” If different ticket prices are available for different seats, then the seating diagram and the ticket prices can be coupled to indicate the price for each available seat.

Once the event information has been uploaded, the event organizer can click a “submit” command that sends the event information to the event management portal for analysis. The event management portal analyses the event information using at least one, or more than one screening technique, and communicates an event status (event accepted or event rejected) back to the event organizer via the event organizer portal 30.

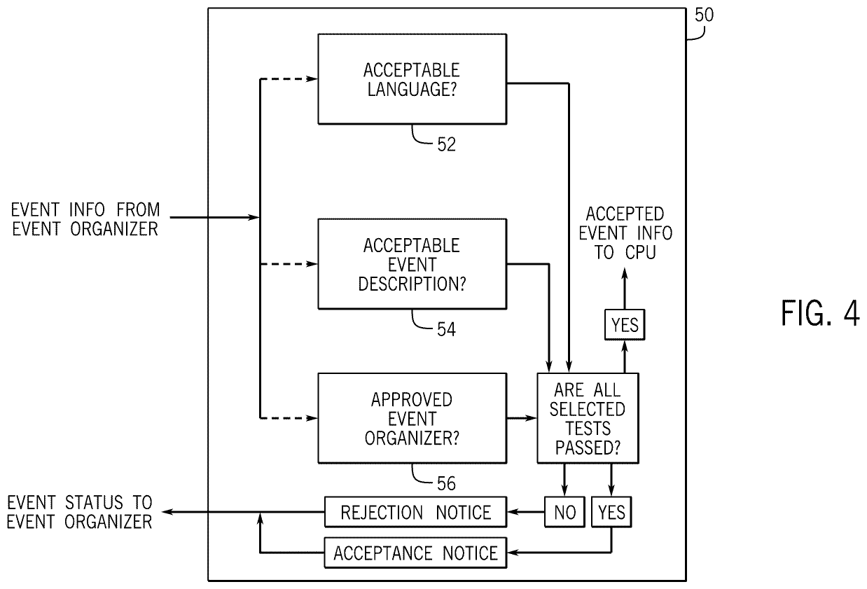

FIG. 4 is a block diagram showing the operation of an event management portal 50. The event management portal 50 receives the submitted event information from the event organizer portal 30, analyzes the event information to determine whether to accept or reject the college event, and sends a rejection notice to the event organizer portal if the event is rejected. In one embodiment, the absence of a rejection notice can automatically trigger an acceptance notice sent to the event organizer portal 30, so that the event organizer becomes immediately aware of an event status, whether accepted or rejected.

FIG. 4 shows blocks for three screening tests, namely an acceptable language test 52, an acceptable event description test 54, and an approved event organizer test 56. Dotted lines pointing to each of the tests 52, 54 and 56 indicate that the operator of the computer system 10 can activate at least one of the tests for implementation, or more than one, or all of the tests. At least one screening test must be selected for the event management portal 50 to perform its screening function of rejecting unacceptable events. The screening test(s) selected can be one or more than one of the illustrated tests 52, 54 and 56, and/or an alternative or improved screening test that is not shown in FIG. 4.

When activated, the acceptable language test 52 can compare all the event information received from the event organizer portal to a list of unacceptable words, which can be profanities, or racist words, or other unacceptable words or phrases. If no unacceptable words or phrases are present, then the acceptable language test 52 is passed. If an unacceptable word or phrase is present, then the test is failed, and the event is rejected.

When activated, the acceptable event description test 54 can compare the event information either a) to a list of unacceptable event types, or b) more restrictively, to a list of acceptable event types, to determine whether to accept or reject the college event. In the first embodiment a), the test is passed if the analysis of event information fails to flag the event as falling within a list of unacceptable event types, and the test is failed if the analysis determines the event to fall within a listed unacceptable event type. In the second embodiment b), the test is passed if the analysis of event information places the event within a listed acceptable event type, and the test is failed if the analysis of event information fails to place the event within a listed acceptable event type.

When activated, the approved event organizer test 56 can compare the event information either a) to a list of disapproved event organizers, or b) more restrictively, to a list of approved event organizers, to determine whether to accept or reject the college event. In the first embodiment a), the test is passed if the event organizer is a person or organization that is not listed as a disapproved event organizer, and the test is failed if the event organizer is listed as disapproved. In the second embodiment b), the test is passed if the event organizer is listed as an approved event organizer, and the test is failed if the event organizer is not on the approved event organizer list.

As shown in FIG. 4, all of the activated tests must be passed in order for an event to be accepted. If an event is accepted, an acceptance notice can be sent to the event organizer portal, and the accepted event information can be sent to the CPU 60 for further processing as described below. If any one of the activated screening tests 52, 54 and/or 56 is failed, the college event is rejected, and a rejection notice is sent to the event organizer portal 30 for communication to the event organizer.

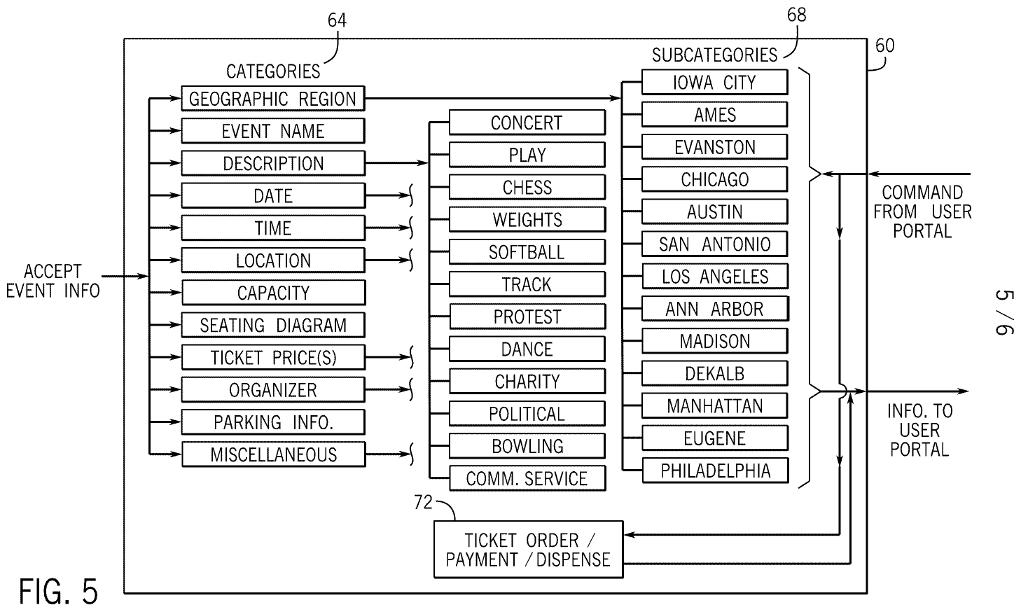

FIG. 5 is a block diagram showing the operation of the central processing unit (CPU) 60 which operates in conjunction with one or more computer system memories (FIG. 1) and responds to commands received from the user portal 80. As shown in FIG. 5, the accepted event information for all accepted events in the multiple geographical regions can initially be stored in the several event information categories 64 to which the information was input. Thereafter, the CPU can sort the event information into multiple event information subcategories 68 corresponding to each event information category. The sorting can be performed autonomously, or in response to user commands received from the user portal 80, or can include some combination of autonomous and command-driven sorting.

By way of example, as shown in FIG. 5, the events information category corresponding to “geographical region” can be sorted according to subcategories corresponding to each geographical region for which event information is stored. In the illustrated example, the geographic regions can be Iowa City or Eastern Iowa (University of Iowa), Ames or Central Iowa (Iowa State University), Evanston or Northern Illinois (Northwestern), Chicago or Northern Illinois (University of Chicago), Austin or Central Texas (University of Texas), San Antonio or Southern Texas (Texas A&M), Los Angeles or Southern California (University of California Los Angeles), Ann Arbor or Southeastern Michigan (University of Michigan), Madison or Southern Wisconsin (University of Wisconsin), DeKalb or Northern Illinois (University of Northern Illinois), Manhattan or Northeastern Kansas (Kansas State University), Eugene or Western Oregon (University of Oregon), and Philadelphia or Southeastern Pennsylvania (University of Pennsylvania). The event information category corresponding to “description” can be sorted into subcategories corresponding to each event type. In the illustrated example, the event types are concert, play, chess, weights, softball, track, protest, dance, charity, political, bowling, and community service. Event information subcategories can also be generated, and sorting can be performed, for the event information categories corresponding to date, time, location, ticket prices, event organizer, and others as desired. The purpose of the sorting (whether performed autonomously, or in response to user commands, or some combination of both), is to provide event information desired by the user in a highly efficient and/or instantaneous manner.

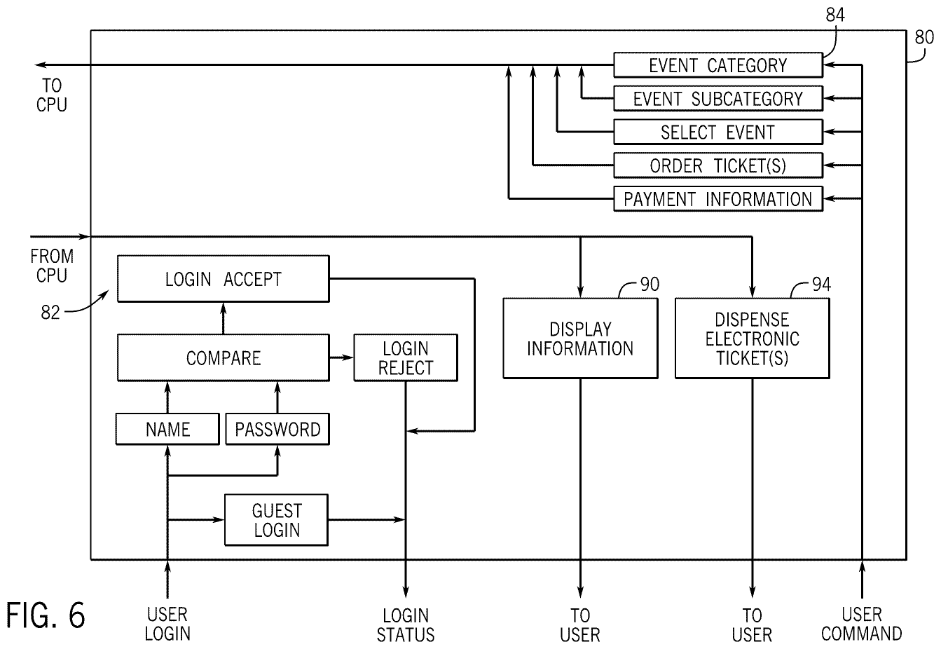

The CPU 60 can also include a ticketing device 72 which can receive ticket orders and payment information, and can dispense electronic tickets, in response to user commands received from the user portal 80. FIG. 6 is a block diagram that illustrates the operation of one embodiment of a user portal 80. The user portal 80 includes a login feature 82 that can enable a guest login (without a user account name or password) for the purpose of accessing and reviewing event information. The login feature also includes an account login (requiring usernames and passwords) for users that wish to order tickets and submit payment information, as well as regular users who desire ongoing accounts. In one embodiment, the user portal 80 and the CPU 60 can be designed to store contact information for the individual users, analyze event preferences for each of the individual users, and notify the individual users of upcoming college events that fall within the respective user's event preferences. In another embodiment, each of the individual users with accounts can receive selective promotional materials for college events falling within event information categories and subcategories that are chosen by the user.

The user portal 80 includes a command menu 84 that the user can employ to access and display the event information for one or more event categories and/or subcategories. For example, the user may select “event category” and/or “event subcategory,” resulting in a display of a listing of available event categories and subcategories. From the listing, the user can then select a specific event category and/or a specific event subcategory, resulting in a listing or other display of applicable events on the display information screen 90. The user can then select a specific event using the “select event” command, resulting in a display of all available information for the selected event, including ticket pricing and available seating, if applicable. The user can then select the “order ticket(s)” command resulting in a display of total price and ticket(s) ordered. The user can then select the command “payment information” and enter the required information, causing the CPU 60 to generate an electronic ticket from the ticketing module 72 and send it to the ticket dispenser 94 in the user module 80, whereupon it can be printed by the user or stored on the user's electronic device.

Various additional features can be included in the system and method of the invention without departing from the spirit and scope of the invention. In one embodiment, the event organizer portal 30 can be designed so that, once the event information for an event has been uploaded and approved, the event organizer can post changes in the date, time or location of the event, or cancellation of the event. In this embodiment, the CPU 60 can be similarly designed to communicate all changes in event information to users who have already ordered and purchased tickets to the event via the user portal 80, and to provide users with an opportunity to cancel their purchase and obtain a refund.

In one embodiment, the event organizer portal 80 and CPU 60 can be designed so that an event organizer can request and receive feedback regarding the number of tickets being sold, the remaining seating capacity, changes in available parking, conflicting events that may result in lower ticket sales for a subject event, comments from attendees, and other information regarding an accepted event. In one embodiment, the event organizer portal 30, CPU 60, and user portal 80 can be designed so that an event organizer can selectively promote the event to specific groups of users with or without a promotion fee. The user portal 80 and CPU 60 can also be designed so that an event organizer can request and obtain analytics describing such features as total revenue, average ticket price, and demographics of the purchasers.

In one embodiment, the user portal 80 and the CPU 60 can be designed so that the user portal 80 receives and generates a “sold out” message to the user if the user selects an event for which seating is no longer available. In various embodiments, the user portal 80 can be designed to display the command menu options for the event information categories and subcategories in different formats. For example, the subcategories corresponding to college names can be displayed as an alphabetical list, a listing by selected groups, a color-coded list, a zoom-in map, or in any suitable format. The subcategories corresponding to event description can be color-coded to distinguish each type of event or can be represented with descriptive graphics. The subcategories corresponding to ticket prices can be represented as $, $$, $$$, or $$$$ to give a preview of the amount of money required, and to enable a user to screen out events that are deemed too expensive.

In one embodiment, the user portal 80 and CPU 60 can be designed so that the user portal 80 includes a “chat box” that enables users to exchange comments, recommendations, and other information regarding upcoming events. In one embodiment, the user portal 80 and CPU 60 can be designed to receive and store additional information about each user, for example, college or geographical region name, year in college (freshman, sophomore, junior, senior, masters, or Ph.D.), college major, anticipated graduation date, and/or phone number, in addition to name and college email address. In one embodiment, the CPU 60 can be designed to store user payment information so that a user can purchase tickets without repeatedly entering the detailed payment information. In one embodiment, the user portal 80 can include an “invite” function that enables users to invite other users and non-users to an event by sending an email invitation.

Many other devices or subsystems may be connected to the computer system 10. The portals and subsystems described above may also be configured in different ways, and/or interconnected in different ways from what is illustrated. The computer system 10 may employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., compact disks (CDs), digital video disks (DVDs), and BLU-RAY disks), electronic-storage media (e.g., solid-state drives and flash media), and other distribution systems.

A computer-readable medium containing the necessary computer software may be loaded into the computer system 10. All or a portion of the computer software stored on the computer-readable medium may then be stored in the system memory 18 and/or various portions of storage device 24. Additionally or alternatively, one or more of the exemplary embodiments described and/or illustrated herein may be implemented in firmware and/or hardware. For example, computer system 10 may be configured as an Application Specific Integrated Circuit (ASIC) adapted to implement one or more of the exemplary embodiments disclosed herein.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered examples, since many other architectures can be implemented to achieve the same functionality.

In some embodiments, all or a portion of the computer system 10 may represent portions of a cloud-computing or network-based environment. Cloud-computing environments may provide pertinent services and applications via the internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In some examples, all or a portion of the computer system 10 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of the computer system 10 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of the computer system 10 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The system and methods described and/or illustrated herein may also integrate one or more of the components or steps described or illustrated herein or include additional components or steps in addition to those disclosed.

The preceding description has been provided to enable others skilled in the art to best utilize various aspects of the computer-implemented system and method disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection or coupling. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented system for widespread dissemination of college event information for multiple geographical regions, comprising:
an event organizer portal accessible by at least one event organizer for each of the multiple geographical regions for receiving event information for a college event from the event organizer;
the event organizer portal including at least an event organizer login interface and a dedicated space for uploading the event information, the event information including multiple event information categories, the event information categories including at least a geographical region name, a description of the college event, a date and time for the event, a location for the event, and at least one ticket price for attending the event;
an event management portal for receiving the event information from the event organizer portal, analyzing the event information to determine whether to accept or reject the college event, and sending a rejection notice to the event organizer portal if the college event is rejected;
a central processing unit for receiving the event information for all college events that are accepted, storing the event information for accepted college events from the multiple geographical regions, and sorting the stored event information according to subcategories within the event information categories; and
an online user portal accessible by individual users, including a user command menu for accessing and displaying the stored event information for one or more of the event information categories and/or subcategories, for selecting a college event from the one or more event information categories and/or subcategories categories, and for ordering one or more tickets to the selected college event.

2. The computer-implemented system of claim 1, wherein the multiple geographical regions comprise at least 25 geographical regions.

3. The computer-implemented system of claim 1, wherein the multiple geographical regions comprise at least 50 geographical regions.

4. The computer-implemented system of claim 1, wherein the event information categories further comprise an event capacity.

5. The computer-implemented system of claim 1, wherein the event information categories further include identification of an event host or event organizer.

6. The computer-implemented system of claim 1, wherein the event management portal analyzes the event information by comparing the event information to specific words and/or phrases that, if present, will trigger sending of a rejection notice.

7. The computer-implemented system of claim 1, wherein the event management portal analyzes the event information by comparing the event information to a list of approved event types, or a list of disapproved event types, to determine whether to accept or reject the college event.

8. The computer-implemented system of claim 5, wherein the event portal analyzes the event information by comparing the event information to a list of approved event organizers, or a list of disapproved event organizers, to determine whether to accept or reject the college

9. The computer system of claim 1, wherein the event information categories further include a seating arrangement for the event and an indication of ticket prices for each remaining available seat.

10. The computer-implemented system of claim 1, wherein the online user portal further comprises a payment receiver and a ticket dispenser.

11. A computer-implemented method for widespread dissemination of college event information for multiple geographical regions including at least ten geographical regions, the method being performed by a computer system comprising at least one processor, the method comprising:
receiving event information for college events from at least one event organizer for each of the geographical regions, the event information including multiple event information categories, the event information categories including at least a geographical region name, a description of the college event, a date and time for the event, a location for the event, and at least one ticket price for attending the event;
analyzing the event information for each college event to determine whether to accept or reject the college event, and sending a rejection notice to the at least one event organizer for each college event that is rejected;
receiving and storing the event information for each college event that is accepted from each of the geographical regions using the at least one processor;
sorting the stored event information from all of the geographical regions according to subcategories within the event information categories; and
providing an online user portal accessible by individual users, including a user command menu for accessing and displaying the stored event information for one or more of the event information categories and/or subcategories, for selecting a college event from the one or more event information categories and/or subcategories, and for ordering one or more tickets to the selected college event.

12. The computer-implemented method of claim 11, wherein the multiple geographical regions comprise at least 25 geographical regions.

13. The computer-implemented method of claim 11, wherein the multiple geographical regions comprise at least 50 geographical regions.

14. The computer-implemented method of claim 11, wherein the event information categories further comprise an event capacity.

15. The computer-implemented method of claim 11, wherein the event information categories further include identification of an event host or event organizer.

16. The computer-implemented method of claim 11, wherein the step of analyzing the event information for each college event comprises the step of comparing the event information to specific words and/or phrases that, if present, will trigger sending of a rejection notice.

17. The computer-implemented method of claim 11, wherein the step of analyzing the event information for each college event comprises the step of comparing the event information to a list of approved event types, or a list of disapproved event types, to determine whether to accept or reject the college event.

18. The computer-implemented method of claim 11, wherein the step of analyzing the event information for each college event comprises the step of comparing the event information to a list of approved event organizers, or a list of disapproved event organizers, to determine whether to accept or reject the college event.

19. The computer-implemented method of claim 11, further comprising the steps of storing contact information for the individual users, analyzing event preferences for each of the individual users, and notifying the individual users of upcoming college events that fall within the event preferences for each of the individual users.

20. The computer system of claim 11, further comprising the steps of receiving payment from at least one of the individual users for the one or more tickets and dispensing the one or more tickets to the at least one individual user.

21. A non-transitory computer-readable medium comprising one or more computer-readable instructions that, when executed by at least one processor of a computing device, cause the computing device to:
receive event information for college events from at least one event organizer for each of multiple geographical regions, the event information including multiple event information categories, the event information categories including at least a geographical region name, a description of the college event, a date and time for the event, a location for the event, and at least one ticket price for attending the event;
analyze the event information for each college event to determine whether to accept or reject the college event, and send a rejection notice to the at least one event organizer for each college event that is rejected;
receive and store the event information for each college event that is accepted from each of the geographical regions in the at least one processor;
sort the stored event information from all of the geographical regions into one or more subcategories within the event information categories; and
provide individual users with an online user portal including a user command menu for accessing and displaying the stored event information for one or more of the event information categories and/or subcategories, for selecting a college event from the one or more event information categories and/or subcategories, and for ordering one or more tickets to the selected college event.
